(19) United States
(12) Patent Application Publication
(10) Pub. No.: US 2006/0237882 A1
(43) Pub. Date: Oct. 26, 2006

(54) Amorphous nylon container and method of manufacture

(75) Inventors: Thomas B. Garman, Mt. Wolf, PA (US); James E. Hiltner, Sylvania, PA (US); Frank J. Patek JR., Whitehouse, OH (US)

Correspondence Address: VENABLE LLP, P.O. BOX 34385, WASHINGTON, DC, 20045-9998, US

(73) Assignee: Graham Packaging Company L.P., York, PA (US)

(21) Appl. No.: 11/472,380

(22) Filed: Jun. 22, 2006

Related U.S. Application Data
(63) Continuation-in-part of application No. 10/329,915, filed on Dec. 26, 2002.

(51) Int. Cl. B29C 49/00

(52) U.S. Cl. 264/537

(57) ABSTRACT

An amorphous nylon container and method of manufacturing same by blow molding the container from a preform so that the container is at a temperature near to and below the glass transition temperature when the container is released from the mold are discussed.

### CROSS REFERENCE TO RELATED APPLICATIONS

This application is a continuation-in-part of Applicants' co-pending U.S. patent application Ser. No. 10/329,915 filed Dec. 26, 2002, which is hereby incorporated by reference.

### BACKGROUND OF THE INVENTION

1. Field of the Invention

The present invention relates generally to plastic containers and more specifically to containers of amorphous nylon construction.

2. Description of Related Art

Containers, typically PET containers, are conventionally made by injection molding a preform which is subsequently blow molded to form the container.

PET containers are sometimes limited for packaging products due to gas transmission rates, elevated temperature limitations, and chemical compatibility with the intended contents. Amorphous nylon containers are sometimes more suited to accommodate products at elevated temperatures and pressures and can withstand chemical attack from certain products that PET cannot.

However, when an amorphous nylon container, manufactured in the same manner as a PET container, is subsequently exposed to hot water, or other polar solvents, surface degradation may occur. For example, when containers are exposed to 65.6° C. (150° F.) temperature for five minutes, the containers exhibit various degrees of surface degradation, appearing as rough and sometimes whitened surface craze. This degradation is likely the partial result of molded-in stresses imparted by the manufacturing process. Specifically, cycles of heating, stretching and cooling that occur during injection molding the preform and blow molding the container create tension in the container that is unable to be released. These molded-in stresses make the container susceptible to degradation upon exposure to hot water, and other polar solvents. The stresses can increase the container's susceptibility to chemical attack from the outside by environmental circumstance or internally by the container's contents.

Accordingly, an amorphous nylon container capable of withstanding hot water exposure without surface degradation and weakening of the container, and a method of manufacture of such a container, are needed.

### BRIEF SUMMARY OF THE INVENTION

The present invention is directed to a method of molding a plastic container that includes blow molding a plastic preform in a blow mold cavity to form a container having a surface portion that is at least partly of amorphous nylon construction, and opening the mold when the container is at a temperature near to and below the onset of the glass transition temperature of amorphous nylon.

The method can also include injecting plastic resin material, including amorphous nylon, into an injection mold cavity to mold a preform. According to this method, at least a portion of a surface of the preform is of amorphous nylon construction having a glass transition temperature. The method can additionally include placing the preform in a blow mold cavity, blow molding the preform in the blow mold cavity to form the container, and releasing the container from the blow mold cavity at a temperature near to and below the onset of the glass transition temperature of the amorphous nylon.

In certain embodiments of the invention, the blow mold cavity is not externally heated. The container can be allowed to cool on its own after release from the blow mold cavity. The container can also be immediately below the onset of the glass transition temperature when the container is released from the blow mold.

In accordance with one embodiment of the invention, the preform can be immediately below the midpoint of the glass transition temperature to about 39° C. (70° F.) above the midpoint of the glass temperature, and is preferably in the range of about 22° C. (40° F.) to about 33° C. (60° F.) above the midpoint of the glass transition temperature prior to being placed in the blow mold cavity. In another embodiment, the preform can range from about 28° C. (50° F.) to about 44° C. (80° F.) above the temperature of the desired container temperature when the container is released from the blow mold cavity. Alternatively, the preform can be about 31° C. (55° F.) to about 42° C. (75° F.) above the temperature of the container when the container is released from the blow mold cavity.

The present invention is further directed to a method of molding a container of amorphous nylon, the amorphous nylon having a glass transition temperature, where the method includes providing a preform having predetermined temperature in a blow mold cavity, molding a container from the from the preform in the blow mold cavity without the addition of external heat, and ejecting the container from the blow mold cavity when the container is at a temperature near to and below the onset of the glass transition temperature of the nylon.

Another subject of the present invention is a method of preventing surface degradation of an amorphous nylon container by blow molding a plastic preform in a blow mold cavity to form a container in which at least a surface portion is of amorphous nylon construction, the amorphous nylon having a glass transition temperature, and releasing the container from the mold when the container is at a temperature near to and below the onset of the glass transition temperature of the amorphous nylon.

A container produced by the above-described methods is also the subject of the present invention.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1A illustrates a DSC (Differential Scanning Calorimeter) curve for one grade of amorphous nylon in the PA 6I/6T family of amorphous nylons;

FIG. 1B illustrates an exploded view of a portion of curve of FIG. 1A;

FIG. 2A illustrates a DSC curve for one grade of amorphous nylon in the PA 12/MACMI family of amorphous nylons; and

FIG. 2B illustrates an exploded view of a portion of curve of FIG. 2A.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

The present invention is directed to a method of making a container having a surface that is at least partly composed of amorphous nylon, wherein the surface of the container does not degrade, or becomes more chemically resistant when exposed to hot water, alcohol, or other solvents. It has been discovered that the chemical resistance of a container having amorphous nylon construction can be enhanced by controlling process variables during manufacture so the temperature of the container upon release from the blow mold is near to and below the glass transition temperature, or T_{g}, of the amorphous nylon. Glass transition temperature varies depending on the nylon used, but can be determined by a person of skill in the art.

The glass transition temperature, T_{g} is defined in basic terms as the temperature at which a reversible change occurs in an amorphous polymer when the polymer is heated. The change is characterized by a rather sudden transition from a hard, glassy or brittle condition to a flexible/pliable or elastomeric condition. The transition occurs when the polymer molecule chains, normally coiled, tangled and motionless at temperatures below the glass transition range, become free to rotate. This temperature varies widely among polymers, and the range can vary from a smaller range of about 1-5° C., to a larger range of about 10-15° C. Graphically, glass transition temperature is the range of values from the first inflection point to the second inflection point on the DSC curve. For simplicity, the T_{g} is often valued at the midpoint of the range. However, T_{g} can be considered as a range visualized by different inflection points along a DSC curve. The first inflection point is an approximation of the onset of conditions within the polymer signifying elasticity, and the second inflection point is an approximation of the endpoint of these characteristics.

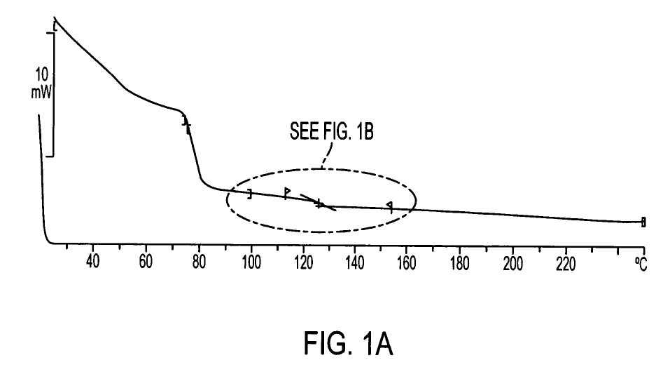

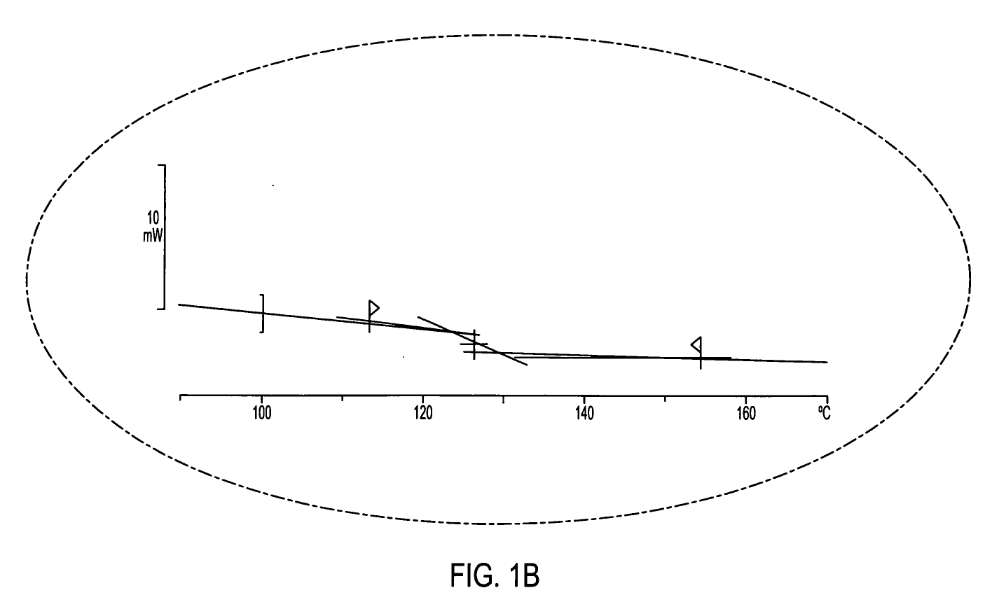

By way of example, the attached Figures illustrate DSC (Differential Scanning Calorimetry) curves for two families of nylon. FIG. 1A illustrates a DSC curve for PA 6I/6T, an exemplary amorphous nylon that is representative of the many amorphous nylons in the art. FIG. 1B focuses on the specific portion of the curve that corresponds to the glass transition temperature range of the amorphous nylon family. As shown more clearly in FIG. 1B, the range (from the first inflection point to the second inflection point on the curve) is approximately 124° C. (255° F.) to 130° C. (266° F.), and the midpoint of the curve shown in FIGS. 1A and 1B is approximated at 127° C. (261° F.).

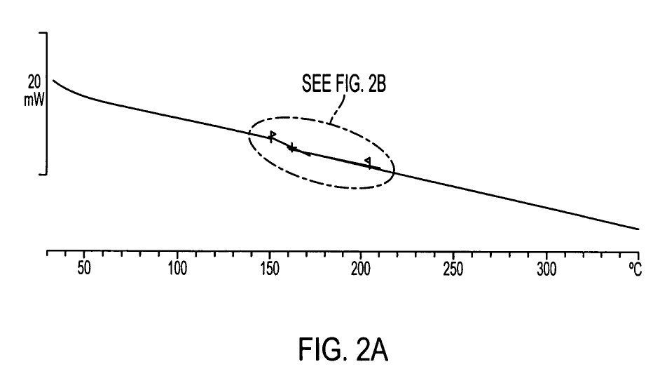

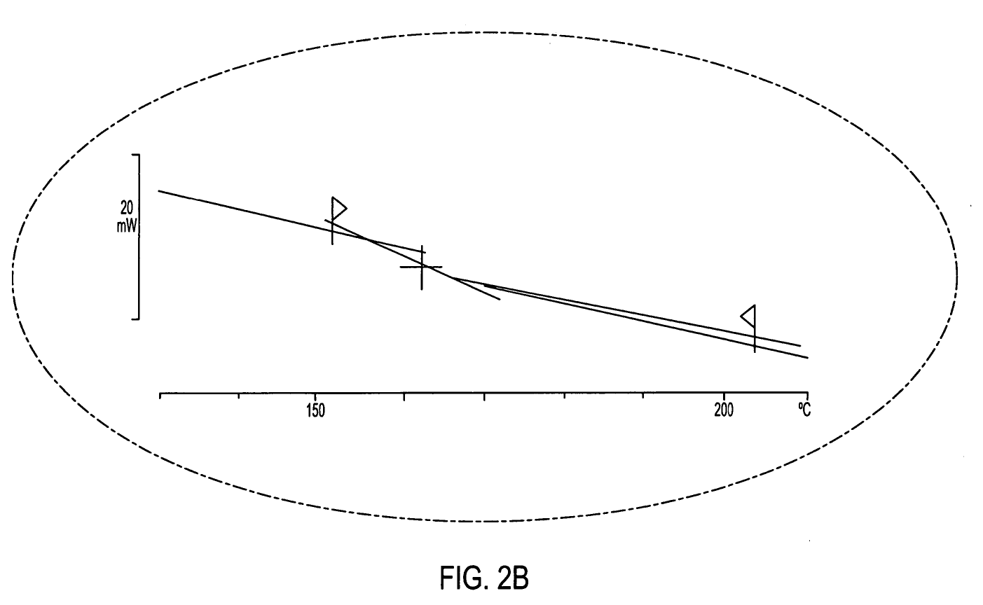

FIG. 2A illustrates a DSC curve for the PA 12/MACMI family of amorphous nylons. The curve of FIG. 2B shows a magnified portion of the curve of FIG. 2A that corresponds to the glass transition temperature range of the amorphous nylon family. PA 12/MACMI is another representative of commonly used amorphous nylons. Here, the glass transition temperature can be approximated as the range of about 155° C. (311° F.) at onset to about 168° C. (334° F.) at the endpoint. The midpoint is approximately 162° C. (323° F.).

The present invention is applicable to blow molding of nylon containers. In accordance with the invention, the temperature of the amorphous nylon container upon release from the mold is near to and below the onset point of the T_{g}. It should be noted that the T_{g}, and therefore the onset point, can fluctuate based on various factors. A person of skill in the art will be able to determine the range of the T_{g} depending on these factors, such as the precise composition of amorphous nylon, the type of amorphous nylon, environmental factors, etc.

In order to produce the present amorphous nylon container having superior chemical resistance, process variables can be controlled such that the blow molded container is at a temperature near to and below the onset of the glass transition temperature of the amorphous nylon when the blow mold opens and the container is released or removed from the mold. The ejection temperature when the container is released from the mold can be from immediately below the T_{g} of the amorphous nylon to about 15° C., to about 5° C., or to about 1° C. below the onset of the T_{g}. Immediately below is any amount greater than zero degrees to any amount less than 1° C. below the onset of the T_{g}.

For example, in the PA 6I/6T family, having a T_{g} onset temperature of about 124° C. (255° F.), the container temperature can be in the range of, for example, about 110° C. (230° F.) to about 123° C. (254° F.) when the mold opens. In the PA 12/MACMI family, having a T_{g} onset temperature of about 155° C. (311° F.), the container temperature can be in the range of, for example, about 140° C. (284° F.) to immediately below 155° C. (311° F.) when the container is released from the blow mold.

When the amorphous nylon container is released from the blow mold within the temperature ranges described above, the container is cool enough to hold it's shape, yet hot enough so that the polymer continues to relax from any stress incurred during the molding process. The process described herein allows for a reduction of molded-in stresses, such as stress due to biaxial stretching during blow-molding.

It is believed that the stretching of the nylon material during the blow molding operation gives rise to an amorphous nylon surface condition that causes degradation and whitening when exposed to hot water, or other polar solvents, after blowing. Technically speaking, the degradation effect is believed to be the result of orientation of the polymer chains and/or level and type of crystallinity within the laminar layers of the blow molded bottle. Based on this assumption, variables that should cause a change in these conditions were selected for modification. They include blow mold temperature, injection temperature, injection time, and cure time. Blow mold temperature is the temperature of the blow mold when the container is blown. Injection temperature is the temperature of the injection mold when the preform is injection molded. Injection time is the time required to inject material into the injection mold to form the preform, and cure time is the time the preform is cured in the mold.

Stretch blow molding processes for fabricating containers, also referred to as injection stretch blow molding processes, typically involve four stages of operation. These steps can be performed sequentially without interruption, or can be performed at completely different times. At a first stage, one or more resin materials are injected into a preform mold around a core. After injection molding, the preform is transported to a conditioning station. If desired, the conditioning station can be used to bring the preform to a desired pre-blow mold temperature. Next, the preform is directed to a stretch blow mold station. In accordance with the invention, the preform is at a temperature above its T_{g} prior to placement in the blow mold. In the stretch blow mold station, the preform is positioned within a mold cavity, the preform is axially stretched, and is simultaneously or sequentially blow molded to the internal confines of the cavity to form the body of the container.

Alternatively, the preform can be injection molded at one time, stored, and the process resumed at a later time. In this situation, the preform must be brought to a temperature (e.g. heated) where the preform is sufficiently pliable before being placed in the blow mold. This pliability is achieved when the preform is at a temperature is close to or within the glass transition temperature range of the amorphous nylon, and can be accomplished by any means known in the art.

The technique used to achieve the desired container ejection temperature is to have the preform at a desired temperature where the preform is sufficiently pliable before it is placed in the blow mold, and allow the material components of the preform and the subsequent blow molded container to only lose a fraction of the pre-blow mold heat. For example, the preform can be immediately above the midpoint of the T_{g} to about 39° C. (70° F.) above the midpoint of the glass transition temperature when it enters the blow mold. The preform can also be in the range of about 22° C. (40° F.) to about 33° C. (60° F.) above the midpoint of the T_{g} when the preform enters the mold. Alternatively, the preform can be about 28° C. (50° F.) to about 44.0° C. (80° F.) above the desired ejection temperature when introduced to the blow mold. In a particular embodiment, the preform can be from about 28° C. (55° F.) to about 44° C. (75° F.) above the desired ejection temperature when the preform is introduced to the blow mold. In another embodiment, the preform can be about 33° C. (60° F.) to about 39° C. (70° F.). The ejection temperature is controlled by starting the blow molding process with polymer material being above, and preferably significantly above, the midpoint of the T_{g}, then removing residual heat in the blow molded container to promote shape retention. This is accomplished by controlling the blow mold temperature, dwell time, in-mold cure time, and combinations thereof.

The temperature of the blow mold is controllable at the blow mold station. The in-mold dwell time of the blow mold station is critical to the invention. The in-mold dwell time is defined as sum of the time taken to blow mold the container from the preform plus the cure time: the time that the container is allowed to rest in the blow mold. The injection dwell time is the sum of the injection time (time taken to injection mold the preform and cure time (the time the preform sits in the injection mold). The injection dwell time, along with the injection mold temperature and initial melt temperature of the injected polymer, determine the temperature of the molded preform prior to its introduction to the blow mold cavity. Likewise, the blow mold dwell time and the blow mold temperature determine the container's ejection temperature. So as to not limit the rate of bottle production, the blow mold dwell time is deliberately kept shorter than the injection dwell time.

In one embodiment of the invention, the temperature of the preform is the only heat source for the blow mold; the blow mold is not externally heated. The very hot preform and the lack of an external heat source can help ease molded-in stresses that occur during blow molding of the container, and can also contribute to post-formation in-mold annealing in the container where the stretched polymer can relax after its final position or shape has been achieved. In another embodiment of the invention, the container is not externally cooled by conventional cooling means; rather, the container is allowed to come to temperature on its own. This allows the amorphous nylon polymer(s) to cool slowly, allowing stress relaxation, thus enhancing the container's ability to withstand chemical attack.

After blow molding, the container is transported to an unload station. U.S. Pat. No. 4,946,367 illustrates a typical four-station injection stretch blow molding system, and is incorporated herein by reference for purposes of background. Injection stretch blow molding, also known as stretch blow molding, constitutes a preferred implementation of the present invention. However, the invention can also be implemented in an injection blow molding process of the type illustrated, for example in U.S. Pat. Nos. 3,707,591 and 4,413,474, the disclosures of which are incorporated herein by reference for purposes of background, or in an injection reheat blow molding operation. Injection reheat blow molding processes involve injection molding preforms, and subsequently reheating the preforms and blow molding the reheated preforms in a blow mold cavity.

A manufacturing process in accordance with the present invention can include injecting plastic resin material, including amorphous nylon, into an injection mold cavity to mold a preform in which at least a portion of the outer or inner surface, or both, is of amorphous nylon construction. The preform is at least partially cured in the injection mold cavity, and then blow molded in a blow mold cavity to form a container in which at least a portion of the inner or outer surface is of amorphous nylon construction. Susceptibility of the amorphous nylon surface portion to degradation can be improved by controlling the time duration of the injection and blow molding processes and the temperature of the performs and blow molds. Controlling these parameters helps to achieve the desired container ejection temperature that is near to and below the glass transition temperature of the amorphous nylon.

A container that is the subject of the present invention has at least a surface portion of amorphous nylon construction—i.e., a portion of the inner or outer surface of the container, or both, of amorphous nylon construction. The container typically includes a hollow body and a finish for attachment of a suitable closure. The container may be entirely of amorphous nylon construction, or may be of multilayered construction in which at least one of the outer layers—i.e., the external and/or internal surface of the container—is of amorphous nylon construction. Other layers may include process regrind layers, post consumer resin layers, barrier layers to protect against migration of gases, water vapor or flavorants through the sidewall of the container, adhesive layers, etc. These additional layers may or may not extend into the finish portion of the container.

As employed in the present application, the term “amorphous nylon” (also known as “amorphous polyamide”) refers to nylons without substantial crystallinity. The term “amorphous nylon” thus refers to those nylons that are substantially lacking in crystallinity, as shown by the lack of an endotherm crystalline melting peak in a Differential Scanning Calorimeter (DSC) test according to ASTM D-3417. Amorphous nylon type PA 6I/6T, (as defined by CAS Reg. No. 25750-23-6) manufactured by the condensation of hexamethylenediamine, terephthalic acid, and isophthalic acid such that 65 to 80 percent of the polymer units are derived from hexamethylene isophthalamide, is currently preferred. Other amorphous nylons can also be employed, including but not limited to nylons PA 12/MACMI and PA NDT/INDT.

### EXAMPLE

To determine favorable parameters for manufacture of an amorphous container being able to resist surface degradation, container samples were manufactured using a specific value for 4 parameters: blow mold temperature, injection temperature, injection time, and cure time. The sample lots were labeled A-L and P-BB, each sample lot having a particular value for each parameter. All containers were of identical geometry and identical PA 6I/6T nylon construction, and were entirely amorphous nylon. The samples were also broken into two groups: one having an injection mold temperature of 12.8° C. (55.0° F.) and the other having a injection mold temperature of 65.6° C. (150° F.). Four containers of each sample lot were tested within about five minutes of manufacture and four containers from each group were allowed to cure for seventy-two hours before testing. Testing for all containers involved exposure to water at 65.6° C. for five minutes, followed by inspection of the outer surface of the container for surface degradation, including particularly whitening of the outer surface. All containers were clear prior to exposure to hot water. The test parameters are set forth in the following table 1.

TABLE 1

| | Blow | | | |
|---|---|---|---|---|
| | Mold | Inj. | Inj. | Cure |
| | Temp. | Temp | Time | Time |
| Sample | (° F.) | (° F.) | (sec.) | (sec.) |
| A | 180 | 55 | 11 | 2 |
| B | 150 | 55 | 11 | 2 |
| C | 100 | 55 | 11 | 2 |
| D | 84 | 55 | 11 | 2 |
| E | 180 | 55 | 8 | 1 |
| F | 150 | 55 | 8 | 1 |
| G | 100 | 55 | 8 | 1 |
| H | 84 | 55 | 8 | 1 |
| I | 180 | 55 | 14 | 2 |
| J | 150 | 55 | 14 | 2 |
| K | 100 | 55 | 14 | 2 |
| L | 84 | 55 | 14 | 2 |
| S | 180 | 150 | 16 | 2 |
| R | 150 | 150 | 16 | 2 |
| Q | 100 | 150 | 16 | 2 |
| P | 84 | 150 | 16 | 2 |
| W | 180 | 150 | 14 | 2 |
| V | 150 | 150 | 14 | 2 |
| U | 100 | 150 | 14 | 2 |
| T | 84 | 150 | 14 | 2 |
| AA | 180 | 150 | 11 | 2 |
| Z | 150 | 150 | 11 | 2 |
| Y | 100 | 150 | 11 | 2 |
| X | 84 | 150 | 11 | 2 |
| EE | 180 | 150 | 9 | 2 |
| DD | 150 | 150 | 9 | 2 |
| CC | 100 | 150 | 9 | 2 |
| BB | 84 | 150 | 9 | 2 |

Of the samples in Table 1 tested within about five minutes of blow molding, the sample B containers were fabricated employing process parameters typical for fabrication of containers of PET construction on the same equipment. Samples I through L had the worst external appearance after exposure to hot water, and samples A through D had the next worst appearance. The containers of sample E had the best external appearance among those employing an injection temperature of 12.8° C. (55.0° F.), and sample AA had the best external appearance among those employing an injection temperature of 65.6° C. (150° F.).

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of molding a plastic container comprising:
blow molding a plastic preform in a blow mold cavity to form a container in which at least a surface portion is of amorphous nylon construction; and
opening the mold when the container is at a temperature near to and below the onset of the glass transition temperature of amorphous nylon.

2. A method of blow molding the container of claim 1, further comprising:
injecting plastic resin material, including amorphous nylon, into an injection mold cavity to mold a preform in which at least a portion of a surface of said preform is of amorphous nylon construction having a glass transition temperature;
placing the preform in a blow mold cavity; and
blow molding said preform in said blow mold cavity to form a container in which at least a surface portion is of amorphous nylon construction,
releasing the container from the blow mold cavity at a temperature near to and below the onset of the glass transition temperature of the amorphous nylon.

3. The method of claim 2, wherein the preform is pliable when placed in the blow mold cavity.

4. The method of claim 3, wherein the preform is about 22° C. (40° F.) to about 33° C. (60° F.) above the midpoint of the glass transition temperature prior to being placed in the blow mold cavity.

5. The method of claim 3, wherein the preform is about 28° C. (50° F.) to about 44° C. (80° F.) above the temperature of the desired container temperature when the container is released from the blow mold cavity.

6. The method of claim 3, wherein the preform is about 31° C. (55° F.) to about 42° C. (75° F.) above the temperature of the container when the container is released from the blow mold cavity.

7. The method of claim 2, wherein the blow mold cavity is not externally heated.

8. The method of claim 2, wherein the container is allowed to cool on its own after release from the blow mold cavity.

9. The method of claim 2, wherein the container is immediately below the onset of the glass transition temperature when the container is released from the blow mold.

10. The container made according to the method of claim 2.

11. A method of molding a container of amorphous nylon, the amorphous nylon having a glass transition temperature, the method comprising:
providing a preform to a predetermined temperature;
placing the preform in a blow mold cavity;
molding the container in the blow mold cavity without the addition of external heat; and
ejecting the container from the blow mold cavity when the container is at a temperature near to and below the onset of the glass transition temperature of the nylon.

12. The method of claim 11, wherein the container is allowed to cool on its own after ejection from the blow mold.

13. The method of claim 11, further comprising injection molding the preform.

14. The method of claim 11, wherein the preform is at a temperature immediately below the midpoint of the glass transition temperature to about 39° C. (70° F.) above the midpoint of the glass transition temperature.

15. A method of preventing surface degradation of an amorphous nylon container comprising:
blow molding a plastic preform in a blow mold cavity to form a container in which at least a surface portion is of amorphous nylon construction, the amorphous nylon having a glass transition temperature; and
releasing the container from the mold when the container is at a temperature near to and below the onset of the glass transition temperature of the amorphous nylon.

16. The method of claim 15, further comprising heating or injection molding the preform prior to blow molding the preform.

17. The method of claim 15, wherein the blow mold is not externally heated.

18. The method of claim 15, wherein the preform is about 31° C. (55° F.) to about 42° C. (75° F.) above the temperature of the container when the container is released from the blow mold cavity.

19. The method of claim 15, wherein the preform is pliable.

20. The method of claim 3, wherein the preform is about 22° C. (40° F.) to about 33° C. (60° F.) above the midpoint of the glass transition temperature prior to being placed in the blow mold cavity.
